(19) United States
(12) Patent Application Publication
(10) Pub. No.: US 2022/0065348 A1
(43) Pub. Date: Mar. 3, 2022

(54) SWIVEL SEAL ASSEMBLY

(71) Applicant: Trelleborg Sealing Solutions Germany GmbH, Stuttgart (DE)

(72) Inventors: John J. Mountz, Kendallville, IN (US); Katherine A. Quigley, Bloomfield, IN (US)

(73) Assignee: Trelleborg Sealing Solutions Germany GmbH, Stuttgart (DE)

(21) Appl. No.: 17/445,881

(22) Filed: Aug. 25, 2021

Related U.S. Application Data
(60) Provisional application No. 63/071,452, filed on Aug. 28, 2020.

(51) Int. Cl. F16J 15/3204; F16L 27/08

(52) U.S. Cl. CPC F16J 15/3204; F16L 27/0845

(57) ABSTRACT

A composite seal for a swivel seal assembly includes an elastomeric seal ring bonded to at least one anti-extrusion ring. The elastomeric seal ring includes an outside annular valley formed along an outside diameter, the outside annular valley separating a first outside sealing annular interface apart from a second outside sealing annular interface. The first outside sealing annular interface is disposed adjacent to a first axial side and the second outside sealing annular interface is disposed adjacent to the at least one anti-extrusion ring. The elastomeric seal ring includes an inside annular valley formed along an inside diameter, the inside annular valley separating a first inside sealing annular interface apart from a second inside sealing annular interface. The first inside sealing annular interface is disposed adjacent to the first axial side and the second inside sealing annular interface is disposed adjacent to the at least one anti-extrusion ring.

### CROSS-REFERENCE TO RELATED APPLICATIONS

This application claims priority to the provisional application 63/071,452 filed on Aug. 28, 2020, the entire contents of which are hereby incorporated in full by this reference.

### DESCRIPTION

### Field of the Invention

The present invention generally relates to swivel seal assemblies. More particularly, the present invention relates to a composite seal for a swivel seal assembly having a novel elastomer ring bonded to at least one anti-extrusion ring.

### Background of the Invention

As is known in the prior art, such as from U.S. Pat. No. 10,619,774, swivel joints are commonly used in the oilfield industry to build rigid yet dynamically configurable flow lines between various pieces of equipment. For example, in oilfield pumping stimulation operations, or fracking operations, swivel joints are often used to connect a number of high-pressure pumping units to a manifold and to connect the manifold to an injection wellhead.

These types of swivel joints typically comprise a tubular male member which is rotatably connected to a tubular female member. The male member comprises a male race and the female member comprises a female race which is configured to be receive the male race. When the male race is positioned in the female race, each of a plurality of outer annular grooves on the male race is aligned with a corresponding inner annular groove on the female race to thereby form plurality of bearing races within which a plurality of bearing balls are received to rotatably connect the male member to the female member.

When the male and female members are connected together, an annulus is formed between the male and female races which is in fluid communication with the flow bore defined by the swivel joint. In order to contain the fluid within the flow bore while still allowing the male and female members to rotate relative to each other, the swivel joint usually includes a dynamic primary seal which is positioned between a nose portion of the male race and an inner end portion of the female race.

However, if the primary seal fails, the flow of pressurized fracking fluid through the annulus can quickly erode the male nose portion and/or the female inner end portion and thereby cause the swivel joint to fail. Also, pressurized fluid will enter the annulus and generate hydrostatic end loads between the male and female races which could cause the bearing races to fail. Therefore, it is common practice to include a second seal to prevent overall assembly failure if the primary seal is breached. However, it remains desirable if a better design of the seal were obtained. Furthermore, it is desirable that such an improved seal could negate the need for a secondary seal, such that assembly costs and complication could be reduced.

Accordingly, there still exists a need for an improved seal. The present invention fulfills these needs and provides other related advantages.

### SUMMARY OF THE INVENTION

Referring now to the drawings, and more particularly to FIGS. 7 and 8, an exemplary embodiment of a swivel seal assembly provided according to the present invention is illustrated. The swivel seal assembly may be configured for axial sealing and, when installed, bear against a metal surface and cover a pre-existing extrusion gap between mating hardware. The swivel seal assembly includes an elastomer seal body that is coupled with an anti-extrusion device that is configured to reduce extrusion of the seal body into the extrusion gap when pressure is applied to the seal body. The swivel seal assembly may be used, for example, in systems where oil and high-pressure gas are present, such as hydraulic fracturing applications. The swivel seal assembly may be installed and operated without the need for interim adjustments or lubrication.

The seal body may be in the shape of an annular ring, as illustrated, and formed of a suitable elastomer, such as rubber or another type of elastic polymer. As best illustrated in the cross-sectional views, the seal body may have an outer diameter surface corresponding to an outer diameter and an inner diameter surface corresponding to an inner diameter. In the illustrated embodiments, the outer diameter of the seal body may vary between 85.8 mm and 86.0 mm and the inner diameter of the seal body may be 73.74 mm, giving a maximum thickness of the seal body of approximately 6.2 mm. It should be appreciated that these values may be varied, depending on the dimensions of the gland in which the seal body is installed.

Referring now to FIG. 7, the outer diameter surface and the inner diameter surface may be mirror images of one another. The outer diameter surface and the inner diameter surface may each have a first sealing interface formed adjacent to an exposed axial face of the seal body and a second sealing interface formed adjacent to the anti-extrusion device. The seal body may have a section of non-linearly variable thickness between the exposed axial face and the first sealing interface where the seal body varies in thickness in an axial direction from the exposed axial face to the first sealing interface. A third sealing interface between the anti-extrusion device and the second sealing interface extends from the elastomer body to the mating surface and provides increased seal ability. The thickness of the seal body may vary in a non-linear fashion in the section of non-linearly variable thickness to provide the outer diameter surface and the inner diameter surface a rounded profile in the section of non-linearly variable thickness. A pair of sections of linearly variable thickness may be provided between the section of non-linearly variable thickness and the second sealing interface. The sections of linearly variable thickness represent sections of the seal body where the thickness of the seal body varies linearly in the axial direction toward a region of minimal thickness. The region of minimal thickness includes a rounded valley where the thickness of the seal body is a minimum, which allows compressibility and increases seal ability across a range of axial groove widths. The first seal interface and the second seal interface may, on the other hand, represent the regions of the seal body where the thickness is at a maximum to seal against a gland when installed.

To reduce the risk of the seal body extruding into an extrusion gap, the anti-extrusion device may include a pair of backup rings that are bonded to the seal body and may reside against the sealing interface. The backup rings may be formed of a material that has a greater rigidity than the seal body, including but not limited to metal, such as stainless steel, and/or a rigid polymer, such as polyether ether ketone (PEEK). In some embodiments, the backup rings comprise the same material, but it should be appreciated that the backup rings may be formed of different materials.

Each backup ring may abut against a rounded axial extension of the seal body so the backup rings clamp the axial extension therebetween. The axial extension may, for example, define an axial length that is greater than its thickness. The axial extension may have an axial length that is slightly greater than a corresponding axial length of each backup ring so that the axial extension has a portion that extends axially further than an exposed axial face of both backup rings. In this respect, the backup rings may define a gap therebetween that is substantially filled by the axial extension of the seal body, with the portion of the axial extension extending out of the gap. In this respect, the portion of the axial extension that extends out of the gap can also contact part of the gland in which the swivel seal assembly is disposed. The exposed axial faces of the seal body and the backup rings may extend generally in parallel, as illustrated.

The rounded axial extension of the seal body will compress during assembly of the male and female tubular members. Once installed, the rounded axial extension of the seal will be in-line with the backup rings therefore all axial faces of the seal will be in full contact with mating groove surface eliminating any gap.

A total axial length of the swivel seal assembly may be between 9.93 mm and 10.13 mm, with the seal body having a face-to-face axial length of approximately 6.1 mm and the backup rings having an axial length of approximately 3.7 mm. In some embodiments, the axial length of the backup rings may be a fraction of the total length of the seal, such as one-third to one-half the total length of the seal. The portion of the axial extension that extends past the backup rings may have an axial length of approximately 0.1 mm to 0.3 mm. The swivel seal assembly may define a total thickness of between 6.0 mm and 6.2 mm. It should be appreciated that these dimensions are exemplary only, and the dimensions may be varied to different applications and gland dimensions.

Referring now to FIG. 8, another exemplary embodiment of a swivel seal assembly provided according to the present invention is illustrated. The swivel seal assembly of FIG. 8 also includes an elastomer seal body bonded to an anti-extrusion device, similar to the previously described swivel seal assembly. The seal body and the anti-extrusion device may both have an annular ring shape, as illustrated, but the shape of either element may be adjusted to fit the gland in which the swivel seal assembly is installed. The exemplary swivel seal assembly may have an overall outer diameter between 85.37 mm and 86.39 mm and an inner diameter of 73.69 mm. It should be appreciated that these values may be varied depending on the application and dimensions of the gland in which the swivel seal assembly is installed.

Unlike the previously described seal body illustrated in FIG. 7, the seal body of the swivel seal assembly illustrated in FIG. 8 has an inner diameter surface and an outer diameter surface that are not mirror images of one another with a plurality of variable thickness sections. The seal body may include an exposed axial face that has a linearly variable thickness. The seal body may have a first section of variable thickness adjacent to the exposed axial face. In the first section of variable thickness, the inner diameter surface defines a relatively flat surface while the outer diameter surfaces defines a surface with a rounded profile. In a second section of variable thickness adjacent to the first section of variable thickness, the outer diameter surface may have a rounded profile that extends to a first sealing interface and a linearly tapered profile while the inner diameter surface has a linearly tapered profile throughout the second section of variable thickness. In a third section of variable thickness, the outer diameter surface may have a linearly tapered profile while the inner diameter surface may have a rounded profile including a plateau defining a region where the inner diameter of the seal body is at a maximum. In a fourth section of variable thickness, the outer diameter surface may have a rounded profile including a valley defining a region where the outer diameter of the seal body is at a minimum and the inner diameter surface may have a rounded profile, which allows compressibility and increases seal ability across a range of axial groove widths. As can be appreciated, the valley of the outer diameter surface and the plateau of the inner diameter surface may be radially offset from one another. In a fifth section of variable thickness, the outer diameter surface and the inner diameter surface may both have a linearly tapered profile that ends at a section of constant thickness adjacent to where the seal body is bonded to the anti-extrusion device.

The anti-extrusion device is provided in the form of a backup ring bonded to an axial face of the seal body. As illustrated, an axial face of the backup ring may be bonded to the axial face of the seal body so the backup ring and the seal body are in face-to-face contact. The thickness of the backup ring may be constant and equal to the thickness of the seal body in the section of constant thickness. Similar to the previously described anti-extrusion device, the backup ring may comprise a material that is more rigid than the elastomeric material of the seal body, including but not limited to a metal such as stainless steel and/or a rigid polymer such as PEEK. The backup ring may be bonded to the seal body in any suitable manner that keeps the backup ring and the seal body together, including but not limited to adhesive bonding and/or heat bonding. The backup ring has an exposed axial face, opposite the axial face that contacts the seal body, that extends generally perpendicular to an inner diameter surface and an outer diameter surface of the backup ring. The exposed axial face of the seal body may extend at an angle, i.e., non-parallel, relative to the exposed axial face of the backup ring, owing to the variable thickness of the exposed axial face of the seal body.

The swivel seal assembly may define a total axial length of between 9.91 mm and 10.16 mm, with the seal body having an axial length of 6.48 mm and the backup ring having an axial length of 3.56 mm. The backup ring may define a constant thickness of between 5.97 mm and 6.22 mm, with the seal body having variable thicknesses in the different sections of variable thickness, as described previously. It should be appreciated that the previously described dimensions are all exemplary only and can be adjusted depending on the application and dimensions of the gland in which the swivel seal assembly is installed.

In reference to FIGS. 1-8, a composite seal (30) of the present invention is configured for a swivel seal assembly (10), the swivel seal assembly having a first part (11) rotatable about a longitudinal axis (12) in comparison to a second part (13), wherein the first and second parts cooperatively form an inside annular groove (15) disposed between the first and second parts, the inside annular groove being cylindrically-shaped and aligned about the longitudinal axis, wherein a gap (20) between the first and second parts is connected to the inside annular groove, wherein the composite seal is configured to be disposed within the inside annular groove to seal the gap, wherein the composite seal is configured to be aligned about the longitudinal axis and is delimited by an inside diameter (31) opposite an outside diameter (32) connected by a first axial side (33) opposite a second axial side (34), wherein the composite seal comprises: an elastomeric seal ring (34) bonded to at least one anti-extrusion ring (36), wherein the at least one anti-extrusion ring is disposed at the second axial side configured to be placed adjacent to the gap when the composite seal is disposed within the inside annular groove; wherein the elastomeric seal ring starts from the first axial side and extends longitudinally along the inside and outside diameters until it reaches the at least one anti-extrusion ring; wherein the elastomeric seal ring includes an outside annular valley (37) formed along the outside diameter, the outside annular valley separating a first outside sealing annular interface (38) apart from a second outside sealing annular interface (39), the first outside sealing annular interface disposed adjacent to the first axial side and the second outside sealing annular interface disposed adjacent to the at least one anti-extrusion ring; and wherein the elastomeric seal ring includes an inside annular valley (40) formed along the inside diameter, the inside annular valley separating a first inside sealing annular interface (41) apart from a second inside sealing annular interface (42), the first inside sealing annular interface disposed adjacent to the first axial side and the second inside sealing annular interface disposed adjacent to the at least one anti-extrusion ring.

In other exemplary embodiments, a transition (43) between the first axial side and the first outside sealing annular interface may be rounded. The first outside sealing annular interface may be an annular edge (38) formed at an intersection of the rounded transition and the outside annular valley. The second outside sealing annular interface may be cylindrical and may align with the outside diameter.

A transition (44 of FIG. 4) between the first axial side and the first inside sealing annular interface may be rounded. The first inside sealing annular interface may be an annular edge (41 of FIG. 4) formed at an intersection of the rounded transition and the inside annular valley.

The second inside sealing annular interface may be cylindrical and aligns with the inside diameter.

The first inside sealing annular interface (41 of FIG. 6) may be cylindrical and may have a larger diameter in comparison to the inside diameter.

The at least one anti-extrusion ring may comprise an outer anti-extrusion ring (36a of FIG. 4) and an inner anti-extrusion ring (36b of FIG. 4) separated by an extension (37) of the elastomeric seal ring, wherein the outer anti-extrusion ring is configured to be placed adjacent to the gap when the composite seal is disposed within the inside annular groove.

The extension of the elastomeric seal ring may at least partially extend a distance (45) beyond the second axial side of the first and second anti-extrusion rings.

The elastomeric seal ring and the at least one anti-extrusion ring may be formed of different materials. The at least one anti-extrusion ring may be formed of a material having a greater rigidity in comparison to the elastomeric seal ring. The elastomeric seal ring may have a lower modulus of elasticity in comparison to the at least one anti-extrusion ring.

The at least one anti-extrusion ring may be formed from any of the following materials: metal, stainless steel or polyether ether ketone (PEEK).

The first axial side may comprise an annular angle (46 of FIG. 6) with respect to the longitudinal axis, the annular angle forming the first axial side that is frustoconical in shape that is sloped downwards towards the outside diameter.

In another exemplary embodiment, best shown in FIG. 4, a composite seal (30a of FIG. 4) is configured for a swivel seal assembly (10), the swivel seal assembly having a first part (11) rotatable about a longitudinal axis (12) in comparison to a second part (13), wherein the first and second parts cooperatively form an inside annular groove (15) disposed between the first and second parts, the inside annular groove being cylindrically-shaped and aligned about the longitudinal axis, wherein a gap (20) between the first and second parts is connected to the inside annular groove, wherein the composite seal is configured to be disposed within the inside annular groove to seal the gap, wherein the composite seal is configured to be aligned about the longitudinal axis and is delimited by an inside diameter (31) opposite an outside diameter (32) connected by a first axial side (33) opposite a second axial side (34), wherein the composite seal comprises: an elastomeric seal ring (34) bonded to at least one anti-extrusion ring (36), wherein the at least one anti-extrusion ring is disposed at the second axial side configured to be placed adjacent to the gap when the composite seal is disposed within the inside annular groove; wherein the elastomeric seal ring starts from the first axial side and extends longitudinally along the inside and outside diameters until it reaches the at least one anti-extrusion ring; wherein the elastomeric seal ring includes an outside annular valley (37) formed along the outside diameter, the outside annular valley separating a first outside sealing annular interface (38) apart from a second outside sealing annular interface (39), the first outside sealing annular interface disposed adjacent to the first axial side and the second outside sealing annular interface disposed adjacent to the at least one anti-extrusion ring; wherein the elastomeric seal ring includes an inside annular valley (40) formed along the inside diameter, the inside annular valley separating a first inside sealing annular interface (41) apart from a second inside sealing annular interface (42), the first inside sealing annular interface disposed adjacent to the first axial side and the second inside sealing annular interface disposed adjacent to the at least one anti-extrusion ring; wherein an outside transition (43 of FIG. 4) between the first axial side and the first outside sealing annular interface is rounded; wherein the first outside sealing annular interface is an annular edge (38 of FIG. 4) formed at an intersection of the rounded transition and the outside annular valley; wherein the second outside sealing annular interface is cylindrical and aligns with the outside diameter; wherein an inside transition (44 of FIG. 4) between the first axial side and the first inside sealing annular interface is rounded; wherein the first inside sealing annular interface is an annular edge (41 of FIG. 4) formed at an intersection of the rounded transition and the inside annular valley; wherein the second inside sealing annular interface is cylindrical and aligns with the inside diameter; wherein the at least one anti-extrusion ring comprises an outer anti-extrusion ring (36a) and an inner anti-extrusion ring (36b) separated by an extension (37) of the elastomeric seal ring, wherein the outer anti-extrusion ring is configured to be placed adjacent to the gap when the composite seal is disposed within the inside annular groove; and wherein the elastomeric seal ring and the at least one anti-extrusion ring are formed of different materials.

In other exemplary embodiments, the extension of the elastomeric seal ring may at least partially extend a distance (45) beyond the second axial side of the first and second anti-extrusion rings.

The at least one anti-extrusion ring may be formed of a material having a greater rigidity in comparison to the elastomeric seal ring.

In another exemplary embodiment, best shown in FIG. 6, a composite seal (30b of FIG. 6) is configured for a swivel seal assembly (10), the swivel seal assembly having a first part (11) rotatable about a longitudinal axis (12) in comparison to a second part (13), wherein the first and second parts cooperatively form an inside annular groove (15) disposed between the first and second parts, the inside annular groove being cylindrically-shaped and aligned about the longitudinal axis, wherein a gap (20) between the first and second parts is connected to the inside annular groove, wherein the composite seal is configured to be disposed within the inside annular groove to seal the gap, wherein the composite seal is configured to be aligned about the longitudinal axis and is delimited by an inside diameter (31) opposite an outside diameter (32) connected by a first axial side (33) opposite a second axial side (34), wherein the composite seal comprises: an elastomeric seal ring (34) bonded to at least one anti-extrusion ring (36), wherein the at least one anti-extrusion ring is disposed at the second axial side configured to be placed adjacent to the gap when the composite seal is disposed within the inside annular groove; wherein the elastomeric seal ring starts from the first axial side and extends longitudinally along the inside and outside diameters until it reaches the at least one anti-extrusion ring; wherein the elastomeric seal ring includes an outside annular valley (37) formed along the outside diameter, the outside annular valley separating a first outside sealing annular interface (38) apart from a second outside sealing annular interface (39), the first outside sealing annular interface disposed adjacent to the first axial side and the second outside sealing annular interface disposed adjacent to the at least one anti-extrusion ring; and wherein the elastomeric seal ring includes an inside annular valley (40) formed along the inside diameter, the inside annular valley separating a first inside sealing annular interface (41) apart from a second inside sealing annular interface (42), the first inside sealing annular interface disposed adjacent to the first axial side and the second inside sealing annular interface disposed adjacent to the at least one anti-extrusion ring; wherein a transition (43 of FIG. 6) between the first axial side and the first outside sealing annular interface is rounded; wherein the first outside sealing annular interface is an annular edge (38 of FIG. 6) formed at an intersection of the rounded transition and the outside annular valley; wherein the second outside sealing annular interface is cylindrical and aligns with the outside diameter; wherein the second inside sealing annular interface is cylindrical and aligns with the inside diameter; wherein the first inside sealing annular interface (41 of FIG. 6) is cylindrical and has a larger diameter in comparison to the inside diameter; wherein the elastomeric seal ring and the at least one anti-extrusion ring are formed of different materials; and wherein the first axial side comprises an annular angle (46 of FIG. 6) with respect to the longitudinal axis, the annular angle forming the first axial side that is frustoconical in shape that is sloped downwards towards the outside diameter.

In other exemplary embodiments, the at least one anti-extrusion ring may be formed of a material having a greater rigidity in comparison to the elastomeric seal ring.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains. Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a sectional view taken through a simplistic representation of a swivel seal assembly;

FIG. 2 is an enlarged view of the structure of FIG. 1 taken along lines 2-2;

FIG. 3 is a front view of a first embodiment of a composite seal of the present invention;

FIG. 4 is an enlarged sectional view of the structure of FIG. 3 taken along lines 4-4;

FIG. 5 is a front view of a second embodiment of a composite seal of the present invention;

FIG. 6 is an enlarged sectional view of the structure of FIG. 5 taken along lines 5-5;

FIG. 7 is a sectional view of the composite seal of FIG. 4 installed within the structure of FIG. 2; and

FIG. 8 is a sectional view of the composite seal of FIG. 6 installed within the structure of FIG. 2.

### DETAILED DESCRIPTION OF THE PREFERRED EMBODIMENTS

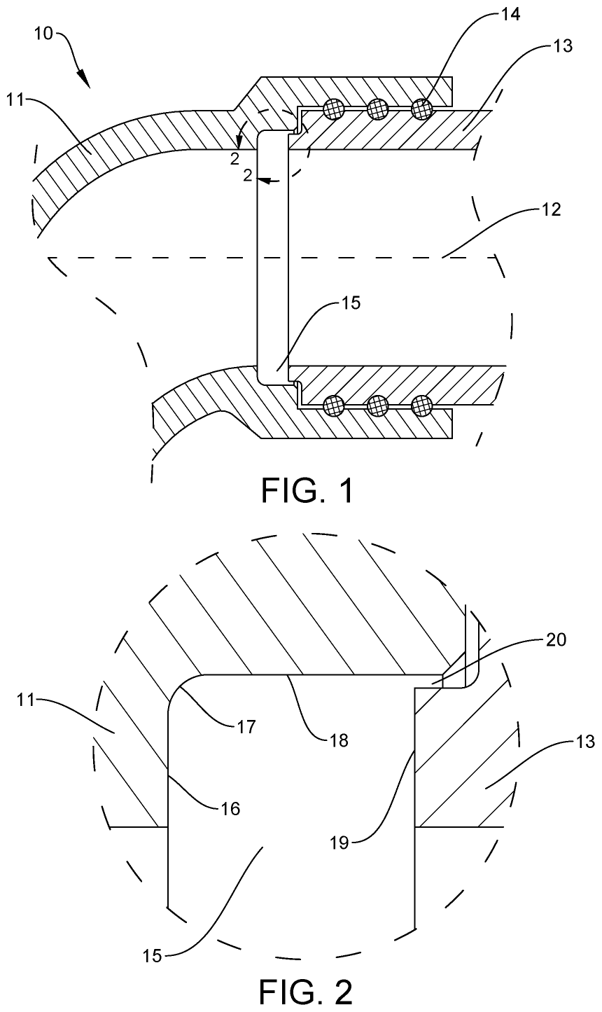

FIG. 1 is a sectional view taken through a simplistic representation of a swivel seal assembly 10, where the seal itself has been removed. Actual swivel seal assemblies may be much more complicated in design, but the embodiment shown herein was simplified to help focus the reader on the important aspects of the present invention. The swivel seal assembly has a first part 11 that is rotatable about a longitudinal axis 12 in comparison to a second part 13. A plurality of ball bearings 14 facilitate the smooth rotation between the first and second parts. The ball bearings may be disposed with one, two, three or any number of races as needed by any specific design. Those skilled in the art of swivel joints and sealing will understand that a multitude of variations are possible for such swivel seal assemblies such that no further discussion is needed herein.

FIG. 2 is an enlarged view of the structure of FIG. 1 taken along lines 2-2 where one can better see that the first and second parts cooperatively form an inside annular groove 15 (i.e. gland) disposed between the first and second parts. The inside annular groove is cylindrically-shaped and aligned about the longitudinal axis. The inside annular groove has a first axial face 16 formed in the first part 11 that is connected by an optional radius 17 to a perpendicularly disposed inside cylindrical surface 18. A second axial face 19 is formed in the second part 13 that faces the first axial face 16. A gap 20 can be seen between the first and second parts. It is this gap 20 that must be sealed by the seal such that any fluid inside the first and second parts does not escape outwardly.

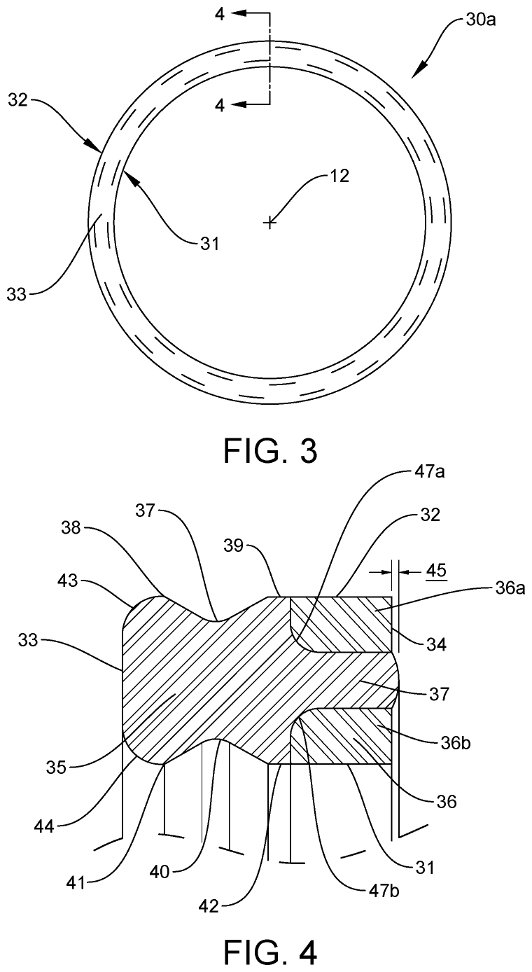

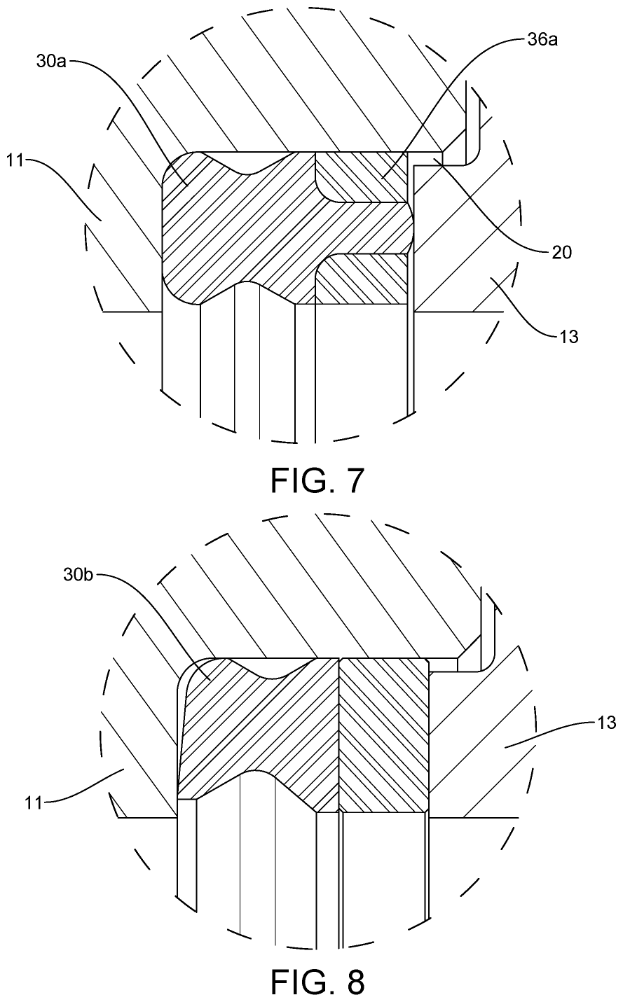

FIG. 3 is a front view of a first embodiment of a composite seal 30a of the present invention and FIG. 4 is an enlarged sectional view of the structure of FIG. 3 taken along lines 4-4. FIG. 7 is a sectional view of the composite seal of FIG. 4 installed within the structure of FIG. 2. The composite seal 30a is configured to be disposed within the inside annular groove 15 to seal the gap 20 as will be best shown later in FIG. 7. The composite seal 30a is configured to be aligned about the longitudinal axis 12 and is delimited by an inside diameter 31 opposite an outside diameter 32 connected by a first axial side 33 opposite a second axial side 34.

This embodiment shows an elastomeric seal ring 35 bonded to at least one anti-extrusion ring 36. The at least one anti-extrusion ring 36 is disposed at the second axial side configured to be placed adjacent to the gap 20 when the composite seal is disposed within the inside annular groove 15 as is best shown in FIG. 7.

In this embodiment, the at least one anti-extrusion ring 36 comprises an outer anti-extrusion ring 36a and an inner anti-extrusion ring 36b separated by an extension 37 of the elastomeric seal ring. It is noted that the outer anti-extrusion ring 36a is configured to be placed adjacent to the gap 20 when the composite seal is disposed within the inside annular groove.

The elastomeric seal ring 35 starts from the first axial side 33 and extends longitudinally along the inside and outside diameters until it reaches the at least one anti-extrusion ring 36. The elastomeric seal ring 35 includes an outside annular valley 37 formed along the outside diameter 32. The outside annular valley 37 separates a first outside sealing annular interface 38 apart from a second outside sealing annular interface 39. The first outside sealing annular interface is disposed adjacent to the first axial side. The second outside sealing annular interface is disposed adjacent to the at least one anti-extrusion ring.

The elastomeric seal ring also includes an inside annular valley 40 formed along the inside diameter. The inside annular valley separates a first inside sealing annular interface 41 apart from a second inside sealing annular interface 42. The first inside sealing annular interface is disposed adjacent to the first axial side. The second inside sealing annular interface is disposed adjacent to the at least one anti-extrusion ring.

As can be seen in FIG. 4, a transition 43 is between the first axial side and the first outside sealing annular interface. This transition is rounded. The rounded transition 43 and the left part of the outside annular valley 37 meet to form an annular edge 38. Thus, the first outside sealing annular interface 38 is the annular edge formed at the intersection of the rounded transition 43 and the outside annular valley. The second outside sealing annular interface 39 is cylindrical and aligns with the outside diameter 32. The outside diameter 32 of the second outside sealing annular interface 39 is the same as the outside diameter of the outer anti-extrusion ring 36a.

Likewise, a transition 44 is between the first axial side and the first inside sealing annular interface. This transition is also rounded. The rounded transition 44 and the left part of the inside annular valley 40 meet to form an annular edge 41. Thus, the first inside sealing annular interface 41 is the annular edge formed at the intersection of the rounded transition 44 and the inside annular valley. The second inside sealing annular interface 42 is cylindrical and aligns with the inside diameter 31. The inside diameter 31 of the second inside sealing annular interface 42 is the same as the inside diameter of the inner anti-extrusion ring 36b. Finally, the extension 37 of the elastomeric seal ring at least partially extends beyond the second axial side 34 of the first and second anti-extrusion rings. This extension distance is noted as numeral 45.

As shown in FIG. 4, both the outer anti-extrusion ring 36a and the inner anti-extrusion ring 36b are bonded to the extension 37 of the elastomeric seal ring. To facilitate a good bonding and to increase reliability the annular corners of the extension 37 each have an annular radius 47a and 47b.

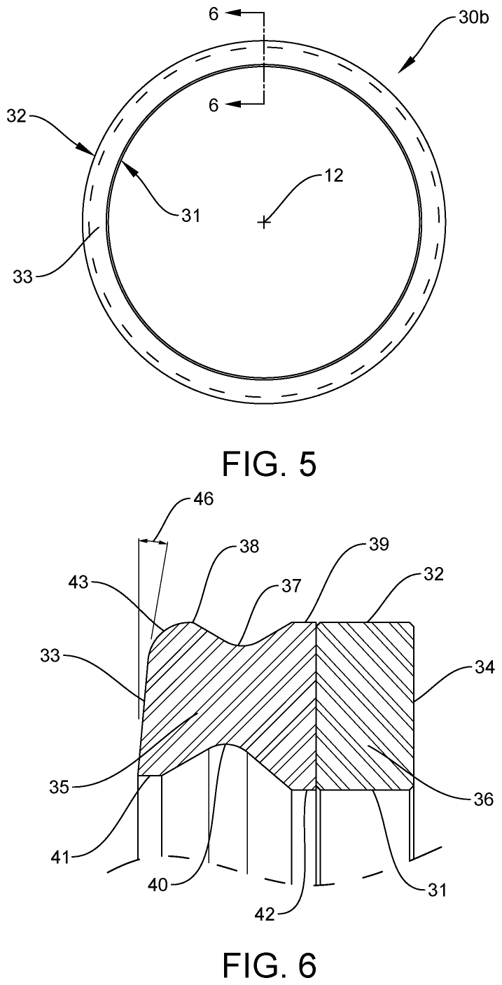

FIG. 5 is a front view of a second embodiment of a composite seal 30b of the present invention and FIG. 6 is an enlarged sectional view of the structure of FIG. 5 taken along lines 6-6. FIG. 8 is a sectional view of the composite seal of FIG. 6 installed within the structure of FIG. 2. The structure shown in FIGS. 5 and 6 is very similar to FIGS. 3 and 4, but differs in structure as now described.

First, the at least one anti-extrusion ring 36 is a single structure. Second, the contour of the inner diameter of the elastomeric seal ring IS different. Now, the first inside sealing annular interface 41 is cylindrical. Furthermore, the first inside sealing annular interface 41 has a larger diameter in comparison to the inside diameter 31. It will be understood by those skilled in the art that the first inside sealing annular interface 41 could also have a similar diameter (not shown) in comparison to the inside diameter 31 or even a smaller diameter (not shown) in comparison to the inside diameter 31.

As can be seen in FIG. 6, the first axial side 33 is angled. Therefore, the first axial side comprises an annular angle 46 with respect to the longitudinal axis 12. The annular angle forms the first axial side that is frustoconical in shape and that is sloped downwards towards the outside diameter 32. It will also be understood by those skilled in the art that the first axial side 33 may also be perpendicular (not shown) to the longitudinal axis.

In these embodiments, the elastomeric seal ring and the at least one anti-extrusion ring are formed of different materials. Additionally, the at least one anti-extrusion ring may be formed of a material having a greater rigidity in comparison to the elastomeric seal ring. In other words, the elastomeric seal ring may have a lower modulus of elasticity in comparison to the at least one anti-extrusion ring. Alternatively, the elastomeric seal ring and the at least one anti-extrusion ring may be formed of the same materials.

The inventors have disclosed two different embodiments that are improvements over the prior art. Prior art seal designs will experience hardware swelling due to the high pressures inside the various tubes and parts of the swivel seal assembly. The present invention allows the seal to maintain sufficient sealing force across the range of part rotations. Specifically, the present invention accommodates a larger tolerance range of gland (inside annular groove 15) width compared to prior art designs. In the present invention, the outer diameter and inner diameter of the elastomer allow for compression in the smallest groove width while also allowing sufficient sealing force at the widest groove width. For example, at the widest groove width, the contour of the inner diameter surface allows for the fluid to energize the seal for increased contact force between the seal and the hardware to offset the reduced squeeze force cause by the widest groove. Said differently, the region of minimal thickness located at the rounded valleys where the thickness of the seal body is a minimum, allows compressibility and increases the seal's ability across a range of axial groove widths. Additionally, bonding the elastomer and polymer backup ring(s) allows simpler installation and reduces the likelihood of leakage occurring between the elastomer and the backup ring. Finally, one of the major failure modes of previous failed designs was because of excessive wear. Therefore, the backup ring(s) material of the present invention will be comprised of low friction and robust material to withstand oscillatory vibrations that the swivel seal assembly produces.

Although several embodiments have been described in detail for purposes of illustration, various modifications may be made to each without departing from the scope and spirit of the invention. Accordingly, the invention is not to be limited, except as by the appended claims.

What is claimed is:

1) A composite seal configured for a swivel seal assembly, the swivel seal assembly having a first part rotatable about a longitudinal axis in comparison to a second part, wherein the first and second parts cooperatively form an inside annular groove disposed between the first and second parts, the inside annular groove being cylindrically-shaped and aligned about the longitudinal axis, wherein a gap between the first and second parts is connected to the inside annular groove, wherein the composite seal is configured to be disposed within the inside annular groove to seal the gap, wherein the composite seal is configured to be aligned about the longitudinal axis and is delimited by an inside diameter opposite an outside diameter connected by a first axial side opposite a second axial side, wherein the composite seal comprises:
an elastomeric seal ring bonded to at least one anti-extrusion ring, wherein the at least one anti-extrusion ring is disposed at the second axial side configured to be placed adjacent to the gap when the composite seal is disposed within the inside annular groove;
wherein the elastomeric seal ring starts from the first axial side and extends longitudinally along the inside and outside diameters until it reaches the at least one anti-extrusion ring;
wherein the elastomeric seal ring includes an outside annular valley formed along the outside diameter, the outside annular valley separating a first outside sealing annular interface apart from a second outside sealing annular interface, the first outside sealing annular interface disposed adjacent to the first axial side and the second outside sealing annular interface disposed adjacent to the at least one anti-extrusion ring; and
wherein the elastomeric seal ring includes an inside annular valley formed along the inside diameter, the inside annular valley separating a first inside sealing annular interface apart from a second inside sealing annular interface, the first inside sealing annular interface disposed adjacent to the first axial side and the second inside sealing annular interface disposed adjacent to the at least one anti-extrusion ring.

2) The composite seal of claim 1, wherein a transition between the first axial side and the first outside sealing annular interface is rounded.

3) The composite seal of claim 2, wherein the first outside sealing annular interface is an annular edge formed at an intersection of the rounded transition and the outside annular valley.

4) The composite seal of claim 1, wherein the second outside sealing annular interface is cylindrical and aligns with the outside diameter.

5) The composite seal of claim 1, wherein a transition between the first axial side and the first inside sealing annular interface is rounded.

6) The composite seal of claim 5, wherein the first inside sealing annular interface is an annular edge formed at an intersection of the rounded transition and the inside annular valley.

7) The composite seal of claim 1, wherein the second inside sealing annular interface is cylindrical and aligns with the inside diameter.

8) The composite seal of claim 1, wherein the first inside sealing annular interface is cylindrical and has a larger diameter in comparison to the inside diameter.

9) The composite seal of claim 1, wherein the at least one anti-extrusion ring comprises an outer anti-extrusion ring and an inner anti-extrusion ring separated by an extension of the elastomeric seal ring, wherein the outer anti-extrusion ring is configured to be placed adjacent to the gap when the composite seal is disposed within the inside annular groove.

10) The composite seal of claim 9, wherein the extension of the elastomeric seal ring at least partially extends a distance beyond the second axial side of the first and second anti-extrusion rings.

11) The composite seal of claim 1, wherein the elastomeric seal ring and the at least one anti-extrusion ring are formed of different materials.

12) The composite seal of claim 1, wherein the at least one anti-extrusion ring is formed of a material having a greater rigidity in comparison to the elastomeric seal ring.

13) The composite seal of claim 1, wherein the elastomeric seal ring has a lower modulus of elasticity in comparison to the at least one anti-extrusion ring.

14) The composite seal of claim 1, wherein the at least one anti-extrusion ring is formed from any of the following materials: metal, stainless steel or polyether ether ketone (PEEK).

15) The composite seal of claim 1, wherein the first axial side comprises an annular angle with respect to the longitudinal axis, the annular angle forming the first axial side that is frustoconical in shape that is sloped downwards towards the outside diameter.

16) A composite seal configured for a swivel seal assembly, the swivel seal assembly having a first part rotatable about a longitudinal axis in comparison to a second part, wherein the first and second parts cooperatively form an inside annular groove disposed between the first and second parts, the inside annular groove being cylindrically-shaped and aligned about the longitudinal axis, wherein a gap between the first and second parts is connected to the inside annular groove, wherein the composite seal is configured to be disposed within the inside annular groove to seal the gap, wherein the composite seal is configured to be aligned about the longitudinal axis and is delimited by an inside diameter opposite an outside diameter connected by a first axial side opposite a second axial side, wherein the composite seal comprises:
an elastomeric seal ring bonded to at least one anti-extrusion ring, wherein the at least one anti-extrusion ring is disposed at the second axial side configured to be placed adjacent to the gap when the composite seal is disposed within the inside annular groove;
wherein the elastomeric seal ring starts from the first axial side and extends longitudinally along the inside and outside diameters until it reaches the at least one anti-extrusion ring;
wherein the elastomeric seal ring includes an outside annular valley formed along the outside diameter, the outside annular valley separating a first outside sealing annular interface apart from a second outside sealing annular interface, the first outside sealing annular interface disposed adjacent to the first axial side and the second outside sealing annular interface disposed adjacent to the at least one anti-extrusion ring;
wherein the elastomeric seal ring includes an inside annular valley formed along the inside diameter, the inside annular valley separating a first inside sealing annular interface apart from a second inside sealing annular interface, the first inside sealing annular interface disposed adjacent to the first axial side and the second inside sealing annular interface disposed adjacent to the at least one anti-extrusion ring;
wherein an outside transition between the first axial side and the first outside sealing annular interface is rounded;
wherein the first outside sealing annular interface is an annular edge formed at an intersection of the rounded transition and the outside annular valley;
wherein the second outside sealing annular interface is cylindrical and aligns with the outside diameter;
wherein an inside transition between the first axial side and the first inside sealing annular interface is rounded;
wherein the first inside sealing annular interface is an annular edge formed at an intersection of the rounded transition and the inside annular valley;
wherein the second inside sealing annular interface is cylindrical and aligns with the inside diameter;
wherein the at least one anti-extrusion ring comprises an outer anti-extrusion ring and an inner anti-extrusion ring separated by an extension of the elastomeric seal ring, wherein the outer anti-extrusion ring is configured to be placed adjacent to the gap when the composite seal is disposed within the inside annular groove; and
wherein the elastomeric seal ring and the at least one anti-extrusion ring are formed of different materials.

17) The composite seal of claim 16, wherein the extension of the elastomeric seal ring at least partially extends a distance beyond the second axial side of the first and second anti-extrusion rings.

18) The composite seal of claim 16, wherein the at least one anti-extrusion ring is formed of a material having a greater rigidity in comparison to the elastomeric seal ring.

19) A composite seal configured for a swivel seal assembly, the swivel seal assembly having a first part rotatable about a longitudinal axis in comparison to a second part, wherein the first and second parts cooperatively form an inside annular groove disposed between the first and second parts, the inside annular groove being cylindrically-shaped and aligned about the longitudinal axis, wherein a gap between the first and second parts is connected to the inside annular groove, wherein the composite seal is configured to be disposed within the inside annular groove to seal the gap, wherein the composite seal is configured to be aligned about the longitudinal axis and is delimited by an inside diameter opposite an outside diameter connected by a first axial side opposite a second axial side, wherein the composite seal comprises:
an elastomeric seal ring bonded to at least one anti-extrusion ring, wherein the at least one anti-extrusion ring is disposed at the second axial side configured to be placed adjacent to the gap when the composite seal is disposed within the inside annular groove;
wherein the elastomeric seal ring starts from the first axial side and extends longitudinally along the inside and outside diameters until it reaches the at least one anti-extrusion ring;
wherein the elastomeric seal ring includes an outside annular valley formed along the outside diameter, the outside annular valley separating a first outside sealing annular interface apart from a second outside sealing annular interface, the first outside sealing annular interface disposed adjacent to the first axial side and the second outside sealing annular interface disposed adjacent to the at least one anti-extrusion ring;
wherein the elastomeric seal ring includes an inside annular valley formed along the inside diameter, the inside annular valley separating a first inside sealing annular interface apart from a second inside sealing annular interface, the first inside sealing annular interface disposed adjacent to the first axial side and the second inside sealing annular interface disposed adjacent to the at least one anti-extrusion ring;
wherein a transition between the first axial side and the first outside sealing annular interface is rounded;
wherein the first outside sealing annular interface is an annular edge formed at an intersection of the rounded transition and the outside annular valley;
wherein the second outside sealing annular interface is cylindrical and aligns with the outside diameter;
wherein the second inside sealing annular interface is cylindrical and aligns with the inside diameter;
wherein the first inside sealing annular interface is cylindrical and has a larger diameter in comparison to the inside diameter;
wherein the elastomeric seal ring and the at least one anti-extrusion ring are formed of different materials; and
wherein the first axial side comprises an annular angle with respect to the longitudinal axis, the annular angle forming the first axial side that is frustoconical in shape that is sloped downwards towards the outside diameter.

20) The composite seal of claim 19, wherein the at least one anti-extrusion ring is formed of a material having a greater rigidity in comparison to the elastomeric seal ring.
